(19) United States
(12) Patent Application Publication
(10) Pub. No.: US 2013/0202018 A1
(43) Pub. Date: Aug. 8, 2013

(54) POWER LINE COMMUNCATION METHOD AND POWER LINE COMMUNICATION SYSTEM

(71) Applicants: Sheng-Hua Li, Taoyuan Hsien (TW); Chi-Hsiung Dai, Taoyuan Hsien (TW); Hao-Hsuan Chen, Taoyuan Hsien (TW); Chia-Wei Chang, Taoyuan Hsien (TW)

(72) Inventors: Sheng-Hua Li, Taoyuan Hsien (TW); Chi-Hsiung Dai, Taoyuan Hsien (TW); Hao-Hsuan Chen, Taoyuan Hsien (TW); Chia-Wei Chang, Taoyuan Hsien (TW)

(21) Appl. No.: 13/620,266

(22) Filed: Sep. 14, 2012

(30) Foreign Application Priority Data
Feb. 8, 2012 (CN) 201210026850.X

(51) Int. Cl. H04B 3/54; H04L 12/56

(52) U.S. Cl. 375/222; 375/257

(57) ABSTRACT

A power line communication (PLC) method includes the steps of: programming a registration code into a micro inverter; enabling a data collector to execute a register step, which includes an operation of registering and saving the registration code to a server, through internet; enabling the data collector to send a message to the server through the internet; enabling the server to deliver an authentication code, which is relative to the registration code, to the data collector through the internet according to the message; and enabling the data collector and the micro inverter to identify each other via a power line based on the authentication code.

### CROSS REFERENCE TO RELATED APPLICATIONS

This Non-provisional application claims priority under 35 U.S.C. §119(a) on Patent Application No(s). 201210026850.X filed in People's Republic of China on Feb. 8, 2012, the entire contents of which are hereby incorporated by reference.

### BACKGROUND OF THE INVENTION

1. Field of Invention

The invention relates to a communication method and system, and in particular, to a power line communication (PLC) method and a PLC system.

2. Related Art

The home network is the essential fundamental construction of the digital home, and the apparatuses in the future digital homes have the network connection functions. The power line communication (PLC) method is one of various methods of implementing the home network. The PLC represents a communication manner for transmitting data, video and audio signals via a power line, and has the transmission frequency bands, which may be divided into the narrowband communication and the broadband communication. With the rapid development and progress of the communication and internet technology, the implementation and requirement of using the low voltage power line to transmit the high-speed data have become increasingly important for people. Because the power line network is the most common resource having the widest coverage, the apparatus can be installed and used in a more convenient and flexible manner, and can connect the broadband network into every home using the existing power line network without the duplication of the investment cost of connection. The user can conveniently access the interne and use the home network communication through the power line socket. Thus, the PLC has the significant characteristics including the elimination of the re-wiring, the elimination of occupying the communication frequency resource, the wide coverage and the convenient connection.

FIG. 1 is a flow chart showing steps of a conventional narrowband power line communication (PLC) method of a solar energy micro inverter. In the step S01, the product data of the micro inverter is obtained. The product data of the micro inverter is, for example, the product code or bar code of the micro inverter.

After the micro inverter and the data collector are installed, the step S02 is executed to deliver the product data of the micro inverter and the data collector to the manufacturer by way of mail or facsimile. The product data of the data collector is, for example, the media access control (MAC) address and the serial number. The user delivers the product data of the micro inverter and the data collector to the original seller or manufacturer, from which the product is purchased, by way of mail or facsimile, and this step takes several working days.

Finally, the step S03 is executed to activate the micro inverter and the data collector so that the data collector and the micro inverter are connected with each other to execute the communication function. The manufacturer activates the micro inverter and the data collector according to the sent-back data so that the micro inverter and the data collector are coupled with each other to execute the communication function.

Although the conventional power line communication (PLC) method for activating the data collector and the micro inverter can let the manufacturer exactly obtain the used condition and used number, the excess manpower and time have to be wasted to deliver the product data of the micro inverter and the data collector, and the micro inverter and the data collector cannot be used immediately before being activated, thereby bringing a lot of inconvenience for the user.

Therefore, it is an important subject to provide a power line communication (PLC) method and a PLC system for enhancing the convenience for a data collector and a micro inverter to identify each other without wasting a lot of time and manpower.

### SUMMARY OF THE INVENTION

In view of the foregoing subject, an object of the invention is to provide a power line communication (PLC) method and a PLC system for enhancing the convenience for a data collector and a micro inverter to identify each other without wasting a lot of time and manpower.

To achieve the above objective, the present invention discloses a narrowband power line communication (PLC) method. The PLC method includes the steps of: programming a registration code into a micro inverter; enabling a data collector to execute a register step, which includes an operation of registering and saving the registration code to a server, through internet; enabling the data collector to send a message to the server through the internet; enabling the server to deliver an authentication code, which is relative to the registration code, to the data collector through the internet according to the message; and enabling the data collector and the micro inverter to identify each other via a power line based on the authentication code.

In one embodiment, the PLC method is applied to narrowband power line communication (PLC).

In one embodiment, each of the registration code and the authentication code is a bar code, and the bar code has 14, 15, 16 or 17 bits.

In one embodiment, the bar code comprises an origin control code, a product place-of-manufacture code and a product-bar-code check code.

In one embodiment, the product-bar-code check code is programmed into the micro inverter through an algorithm.

In one embodiment, the internet is a cloud network.

In one embodiment, the register step further comprises registering a media access control (MAC) address and a serial number of the data collector.

In one embodiment, after the register step, the server saves the registration code, the MAC address and the serial number.

In one embodiment, the message comprises the MAC address of the data collector.

In one embodiment, the internet comprises a router.

In one embodiment, the data collector and the server are connected with the router through Ethernet or a wireless network.

To achieve the above objective, the present invention also discloses a power line communication (PLC) system, which includes a micro inverter, a data collector and a server. The micro inverter has a registration code. The data collector is connected with the micro inverter via a power line, and the server is connected with the data collector through internet. The data collector registers and saves the registration code to the server and sends a message to the server through the internet, and the server delivers an authentication code, which is relative to the registration code, to the data collector through the internet according to the message. Then, the data collector and the micro inverter identify each other based on the authentication code via the power line.

In one embodiment, the PLC system is applied to narrowband power line communication (PLC).

In one embodiment, each of the registration code and the authentication code is a bar code, and the bar code comprises an origin control code, a product place-of-manufacture code and a product-bar-code check code.

In one embodiment, the internet is a cloud network.

In one embodiment, the data collector has a media access control (MAC) address and a serial number.

In one embodiment, the data collector registers the MAC address and the serial number in the server.

In one embodiment, the message comprises the MAC address of the data collector.

In summary, the PLC method and the PLC system of the invention firstly program the unique registration code into the micro inverter, and then use the data collector to execute the register step of registering and saving the mated registration code of the micro inverter to the server through the internet. When the data collector and the micro inverter are required to connect and communicate with each other, the data collector is enabled to send the message to the server through the internet, and the server delivers an authentication code, which is relative to the registration code, to the data collector through the internet according to the message. Finally, the data collector and the micro inverter identify each other based on the authentication code via a power line. If the identification succeeds, then the data collector is connected with the micro inverter to execute the communication function.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a flow chart showing steps of a conventional narrowband power line communication (PLC) method of a solar energy micro inverter;

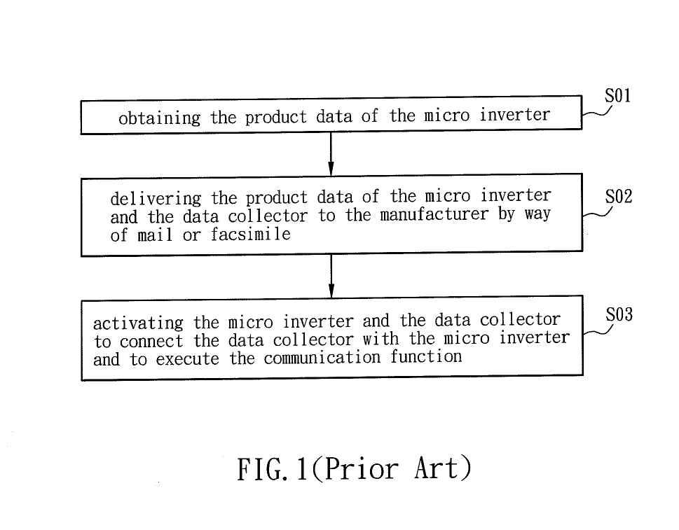

FIG. 2 is a flow chart showing steps of a power line communication (PLC) method according to a preferred embodiment of the invention; and

FIG. 3 is a schematic illustration showing a PLC system according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

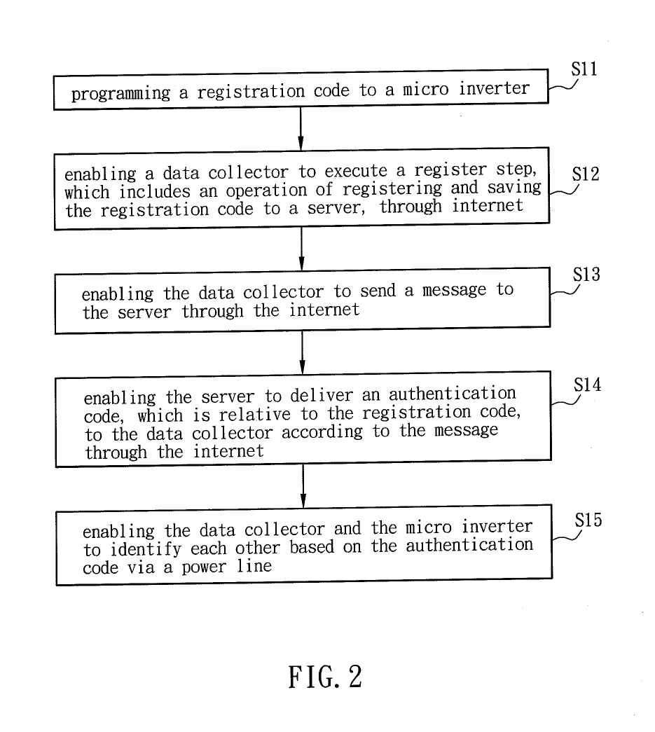

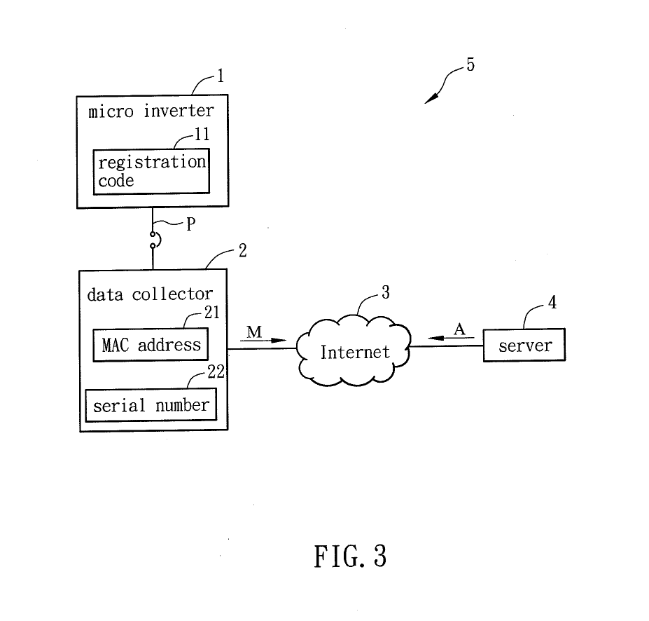

FIG. 2 is a flow chart showing steps of a power line communication (PLC) method according to a preferred embodiment of the invention, and FIG. 3 is a schematic illustration showing a PLC system according to a preferred embodiment of the invention. Referring simultaneously to FIGS. 2 and 3, a power line communication (PLC) method of this embodiment, which is mainly applied to the narrowband PLC, includes steps S11 to S15. A PLC system 5 of this embodiment includes a micro inverter (or microinverter) 1, a data collector 2 and a server 4. The micro inverter 1 of this embodiment is, for example, a solar energy micro inverter. In addition, the micro inverter 1 is connected with the data collector 2 via a power line P, and the data collector 2 is connected with the server 4 through internet 3.

First, the step S11 is executed to program a registration code 11 into the micro inverter 1. The manufacturer programs the registration code 11 into the micro inverter 1 to serve as the basis for identifying the micro inverter 1. The manufacturer programs different registration codes into different micro inverters so that every micro inverter has the unique registration code. The registration code 11 is, for example but without limitation to, a bar code having 15 bits. In another embodiment, the registration code may be a bar code having 14, 15, 16 or 17 bits. The bar code includes an origin control code, a product place-of-manufacture code and a product-bar-code check code. For example, the bar code is, for example, CCCT11010000013, wherein the former three codes “CCC” represent the product control code, which may be otherwise set by digits 0 to 9 or English characters A/a to Z/z; the fourth code “T” represents the product place-of-manufacture code, which may also be otherwise set by the other English characters A/a to Z/z; and the 5^{th} to 15^{th} codes “11010000013” represent the product number bar code and have to be composed of the digits 0 to 9, wherein the 15^{th} code “3” represents the product-bar-code check code, which is programmed into the micro inverter 1 through an algorithm. More specifically, the product number bar codes, such as the 5^{th} to 14^{th} codes “1101000001”, in this embodiment are summated in a predetermined manner. For example, the fifth code “1” is multiplied by 0, the sixth code “1” is multiplied by 1, the seventh code “0” is multiplied by 2, the eighth code “1” is multiplied by 3, the ninth code “0” is multiplied by 4, the tenth code “0” is multiplied by 5, the eleventh code “0” is multiplied by 6, the twelfth code “0” is multiplied by 7, the thirteenth code “0” is multiplied by 8, the 14^{th} code “1” is multiplied by 9, and the above-mentioned products are summated to obtain 13, which is divided by 10 to obtain the quotient of 1 and the remainder of 3. The remainder “3” represents the product check code. It is to be noted that the ten multipliers 0 to 9 may be arbitrarily changed without following the predetermined order to perform the multiplication.

Next, the step S12 is executed to enable the data collector 2 to execute a register step, which includes an operation of registering and saving the registration code 11 to the server 4, through the internet 3. More specifically, the user may register and save the registration code 11 of the micro inverter 1 to the server 4 through the data collector 2 and through the internet 3. The register step further includes an operation of registering a media access control (MAC) address 21 and a serial number 22 of the data collector 2. Thus, the user can not only register and save the registration code 11 to the server 4, but also register and save the MAC address 21 and the serial number 22 of the data collector 2 to the server 4, so that the server 4 saves the MAC address 21 and the serial number 22 of the data collector 2. In addition, the registration code 11 of the micro inverter 1 and the MAC address 21 and the serial number 22 of the data collector 2 are concurrently transmitted and registered to the server 4, so the registration code 11 of the micro inverter 1 mates with the MAC address 21 and the serial number 22 of the data collector 2. In addition, the internet 3 is, for example, a cloud network. The user executes the register step through the data collector 2 and through the cloud network. The internet 3 further includes a router. The data collector 2 and the server 4 are connected with the router through Ethernet or a wireless network (Wi-Fi).

When the data collector 2 and the micro inverter 1 are required to connect and communicate with each other, the step S13 is executed to enable the data collector 2 to send a message M to the server 4 through the internet 3. The message M includes the MAC address 21 of the data collector 2.

In the step S14, the server 4 is enabled to deliver an authentication code A, which is relative to the registration code 11, to the data collector 2 through the internet 3 according to the message M. More specifically, the server 4 saves a plurality of authentication codes A, and the authentication codes A are relative to the registration codes 11 of a plurality of micro inverters 1, respectively. The server 4 delivers the authentication code A, which mates with the registration code 11 of the micro inverter 1, to the data collector 2 through the internet 3 according to the MAC address 21 of the data collector 2 of the message M. The authentication code A of this embodiment is, for example, a bar code, which is the same as the bar code of the registration code. More specifically, when the data collector 2 executes the register step to register and save the registration code 11 of the micro inverter 1 to the server 4 through the internet 3, the server 4 mates the registration code 11 with the MAC address 21 and the serial number 22 for registering the data collector 2. Thus, when the data collector 2 and the micro inverter 1 are required to connect and communicate with each other, the data collector 2 delivers the message M, containing the MAC address 21 and the serial number 22, to the server 4, and the server 4 further searches for the relative registration code 11 according to the MAC address 21 and the serial number 22, and transmits the authentication code A, which is relative to the registration code 11, to the data collector 2.

Finally, the step S15 is executed to enable the data collector 2 and the micro inverter 1 to identify each other based on the authentication code A via the power line P. The data collector 2 identifies the authentication code A, received from the server 4, with the registration code 11 of the micro inverter 1 via the power line P. If the two codes are the same, the data collector 2 is enabled to connect and thus communicate with the micro inverter 1 via the power line P. If the two codes are different from each other, the data collector 2 is disabled from executing the communication function with the micro inverter 1.

The data collector and a plurality of micro inverters may identify each other through a broadcasting and searching mechanism. Thus, if the data collector and one of the micro inverters successfully identify each other, the identifying process ends. If the identification fails, the identifying step is repeatedly executed to identify with the other micro inverters until the identification succeeds. The data collectors, which have successfully passed the mutual identification, can collect the electric power data, such as the power, the voltage, the current and the used state of the micro inverter, converted by the micro inverter and from the solar energy panel, through the narrowband PLC, and thus deliver and save the data to the server through the internet so that the user can monitor the data through the internet in a real-time manner.

In addition, referring to FIG. 3, the invention provides a PLC system 5 including a micro inverter 1, a data collector 2 and a server 4. The PLC system 5 of the invention is applied to the narrowband PLC.

The micro inverter 1 has a registration code 11. The manufacturer programs the registration code 11 into the micro inverter 1 to serve as the basis for identifying the micro inverter 1. The manufacturer programs different registration codes into different micro inverters so that every micro inverter has the unique registration code.

The data collector 2 is connected with the micro inverter 1 via the power line P. The server 4 is connected with the data collector 2 through the internet 3. The data collector 2 receives the registration code of the micro inverter 1 via the power line P, and registers and saves the registration code 11 to the server 4. The server 4 mates the registration code 11 with the MAC address 21 and the serial number 22 for registering the data collector 2. When the data collector 2 and the micro inverter 1 are required to electrically connect and communicate with each other, the data collector 2 sends the message M, containing the MAC address 21 and the serial number 22, to the server 4 through the internet 3, so that the server 4 delivers the authentication code A, which is relative to the registration code 11, to the data collector 2 through the internet 3 according to the message M. Then, the data collector 2 and the micro inverter 1 identify each other based on the authentication code A via the power line P and the registration code 11 of the micro inverter 1.

When the two codes are the same, the data collector 2 is enabled to connect and thus communicate with the micro inverter 1 via the power line P, and to collect the electric power data, converted by the micro inverter 1 and from the solar energy panel, through the narrowband PLC, and the used state of the micro inverter 1 itself, so that these data are delivered and saved to the server 4 through the internet 3 and the user can immediately receive the information and the monitor through the internet 3. If the two codes are different from each other, the data collector 2 and the micro inverter 1 cannot execute the communication function.

The technological characteristics of the micro inverter 1, the data collector 2, the internet 3 and the server 4 are the same as those of the micro inverter 1, the data collector 2, the internet 3 and the server 4 of the above-mentioned embodiment, so detailed descriptions thereof will be omitted.

In summary, the PLC method and the PLC system of the invention firstly program the unique registration code into the micro inverter, and then use the data collector to execute the register step of registering and saving the mated registration code of the micro inverter to the server through the internet. When the data collector and the micro inverter are required to connect and communicate with each other, the data collector is enabled to send the message to the server through the internet, and the server delivers an authentication code, which is relative to the registration code, to the data collector through the internet according to the message. Finally, the data collector and the micro inverter identify each other based on the authentication code via a power line. If the identification succeeds, then the data collector is connected with the micro inverter to execute the communication function. As a result, the data collector of this invention can collect the electric power data, converted by the micro inverter and from the solar energy panel, through the narrowband PLC, and deliver and save the electric power data to the server through the internet, so that the user can monitor the electric power data through the network without directly staying at home.

Compared with the prior art, the PLC method and the PLC system of the invention send the message to the server through the internet, and further deliver the registration code for identifying the micro inverter to the data collector, so that the convenience of the mutual identification between the data collector and the micro inverter can be enhanced, and the consumed time and manpower can be decreased. In addition, since the registration code is the unique bar code, the identification security can be enhanced to prevent others from accessing the system and also prevent the same neighboring products from generating the authentication conflict problem.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A power line communication (PLC) method, comprising the steps of:
programming a registration code into a micro inverter;
enabling a data collector to execute a register step, which comprises an operation of registering and saving the registration code to a server, through internet;
enabling the data collector to send a message to the server through the internet;
enabling the server to deliver an authentication code, which is relative to the registration code, to the data collector through the internet according to the message; and
enabling the data collector and the micro inverter to identify each other based on the authentication code via a power line.

2. The method according to claim 1 being applied to narrowband power line communication (PLC).

3. The method according to claim 1, wherein each of the registration code and the authentication code is a bar code.

4. The method according to claim 3, wherein the bar code has 14, 15, 16 or 17 bits.

5. The method according to claim 3, wherein the bar code comprises an origin control code, a product place-of-manufacture code and a product-bar-code check code.

6. The method according to claim 5, wherein the product-bar-code check code is programmed into the micro inverter through an algorithm.

7. The method according to claim 1, wherein the internet is a cloud network.

8. The method according to claim 1, wherein the register step further comprises registering a media access control (MAC) address and a serial number of the data collector.

9. The method according to claim 8, wherein after the register step, the server saves the registration code, the MAC address and the serial number.

10. The method according to claim 8, wherein the message comprises the MAC address of the data collector.

11. The method according to claim 1, wherein the internet comprises a router.

12. The method according to claim 11, wherein the data collector is connected with the router through Ethernet or a wireless network.

13. The method according to claim 11, wherein the server is connected with the router through Ethernet or a wireless network.

14. A power line communication (PLC) system, comprising:
a micro inverter having a registration code;
a data collector connected with the micro inverter via a power line; and
a server connected with the data collector through internet;
wherein the data collector registers and saves the registration code to the server and sends a message to the server through the internet, the server delivers an authentication code, which is relative to the registration code, to the data collector through the internet according to the message, and the data collector and the micro inverter identify each other based on the authentication code via the power line.

15. The PLC system according to claim 14 being applied to narrowband power line communication (PLC).

16. The PLC system according to claim 14, wherein each of the registration code and the authentication code is a bar code.

17. The PLC system according to claim 16, wherein the bar code comprises an origin control code, a product place-of-manufacture code and a product-bar-code check code.

18. The PLC system according to claim 14, wherein the data collector has a media access control (MAC) address and a serial number.

19. The PLC system according to claim 18, wherein the data collector registers the MAC address and the serial number in the server.

20. The PLC system according to claim 18, wherein the message comprises the MAC address of the data collector.
